(19) United States
(12) Patent Application Publication
(10) Pub. No.: US 2014/0197642 A1
(43) Pub. Date: Jul. 17, 2014

(54) GRAVITY AND BOUYANCY ENGINE DRIVEN GENERATOR

(71) Applicant: Arvind A. Daya, Fayetteville, GA (US)

(72) Inventor: Arvind A. Daya, Fayetteville, GA (US)

(21) Appl. No.: 13/742,550

(22) Filed: Jan. 16, 2013

(51) Int. Cl. F03B 17/02; H02K 7/18

(52) U.S. Cl. CPC F03B 17/02; H02K 7/1807; Y10S 74/09; F03B 17/04
USPC 290/1 D; 60/496; 74/DIG. 9

(57) ABSTRACT

An apparatus which generates electric power from a combination of gravity forces and the inherent buoyancy of the collapsible and expandable bellow skit chamber body immersed in a fluid thus the amount of buoyancy a object has is based on the liquid the object displaces and the weight of the said collapsible chambers in the present invention, the said machine changes the size/buoyancy of the submersed bellow chambers using only gravity as energy source, as the said motor is operating under the principle of both gravity and buoyancy comprises a vertically disposed conveyer immersed in fluid changing the size of the said bellow chambers that operates continuously 24/7, and can be tailored to the requirement thus this present invention can be implemented on high rise building and large commercial establishment or a residential home including the large suburban water towers and produces zero pollution.

### FIELD OF INVENTION

The field of invention relates to a machine and more particularly to a motor (engine) which receives gravity force as energy to produce electricity and operate continuously.

### BACKGROUND OF INVENTION

There is a general need for alternative sources for power which are inexpensive to operate and efficient in operation. Prior art of clean power generators tend to be highly inefficient and lose a great deal of the power generated before that power can be utilized. Additionally, there is a need for power generators type which require little maintenance, and when maintenance is required, are easy to repair.

A combination of multiple said motors accumulatively can be implemented to turn large capacity generator or a large water pumps at the coast, rivers and lakes to pump water up a mountain top with a large reservoir tank to store water whereby to run a large hydro generator continuously.

### SUMMARY OF THE INVENTION

An object of the present invention to employ gravity to generate electrical power.

Another object of the present invention is to provide a system for generating considerable electricity continuously.

Another object of present invention is this device is highly efficient which requires little maintenance with ease.

Still another object of the present invention is this motor can be implemented almost anywhere around the globe.

A further objective of the present invention is to provide a system for generating electricity without polluting the environment.

In accordance with a further aspect of the present invention, a motor operating under the principles of gravity and buoyancy, and more particularly to such a motor wherein a plurality of collapsible reinforced bellow chambers effect movement of a conveyers for both the gravity and buoyancy portions of the motor and consequently, cause rotation of power output shaft respectively connected to the conveyer sprocket chains (carrier).

The gravitational forces associated with falling bodies can, if properly harnessed, generate power as by the turning of a shaft, likewise, the buoyancy forces attendant to the buoyant objects in a liquid can, when harnessed, produce power by turning of a shaft. Therefore, should these falling collapsible bellow chamber be used also as buoyed-up objects, a closed power-generating system can be produced by coupling together the aforementioned rotating shaft. A unique power generator may therefore be formed with the only power input being that required for expendable and collapsible bellow chamber between the gravity and buoyancy portions of this motors.

It is therefore an object of the present invention to provide a motor or a power generator effectively utilizing the forces of both gravity and buoyancy in a closed system with the use of expendable and collapsible bellow chamber to effect movement of a pair of conveyers on a common shaft by both gravity and buoyancy, power input means being provided for intermittent expanding and for collapsing the said bellow chambers with an aid of a set of rail guides between the gravity side and the buoyancy side of the motor, thus guiding each and every collapsible bellow chamber the entire journey around the conveyer sprocket chain.

The present invention concerns an apparatus which generates electrical power from a combination of gravity forces and inherent buoyancy of the expanded bellow chambers immersed in fluid. This is accomplished through a conveyer type of provision on a long continuous sprocket chain/carrier to which pluralities of expandable and collapsible bellow chamber elements are attached along the entire length of the carrier. The two sets of sprocket chain/carrier extends around two pairs of sprocket gears such that movement of the chain causes rotation of gears on a common shaft. The carrier and the buoyant elements are mounted in a housing which contains liquid, preferably water. The said carrier and the buoyant elements are encased in a tank as support structure.

As the buoyant forces of the bellow chamber modules act on the carrier the carrier is turning the sprocket gears thereby the output shaft is turning the gearbox. The said motor is divided in two sides the first side is the expanded bellow buoyant chambers pulling almost half the carrier up, and the second side is the collapsed bellow chambers whereby the gravity is exerting a downward force on the carrier. This entire process of expanding and collapsing the bellow chambers modules at same time exerting the buoyant force and the gravitational force by the said chamber modules is achieved by a rail system. The said rail system as shown FIG. 4 and FIG. 8, is further divided into two sets of rail guides of the sprocket chain carrier whereby on the first side of the motor the outer side of the sprocket chain carrier is one of the rail guides expanding the bellow chambers, the other rail guide is on the inner side of the said sprocket chain carrier that expands the other half of the same set of bellow chambers thus they operate uniformly. One open end of each and every chamber module is connected to both sides of the carrier on the pressurized air pipe connecting frame forming FIG. 7 (#15) in pairs, thus the carrier has an independent sprocket chain guide, and each link in the said carrier has a bearings that rides on the independent sprocket chain guide, furthermore the expended bellow chamber at the very top is collapsing on the first side of the carrier that is exhausting the air through the pressurized air pipe connecting frame forming and transferring the same amount of air in the expending bellow chamber at the bottom that the rail guides are expending in a continuous closed circuit.

In the present invention the motor does not require any external assistance to expand and collapse the chamber modules or to maintain the consistency of the force to turn the output shaft since all of the chamber modules operate in a synchronized mariner, furthermore to shut the said entire motor down is achieved by an additional sets of rail tracks added on the first side of the carrier where the bellow chambers module are expended, thus the said additional sets of rails has a mechanism to interrupt the expansion of the bellow chamber modules by merely changing tracks, thus the bellow chamber modules no longer expends on the first side of the carrier as they travel causing the motor to came to a halt and all the deflated bellow chamber air is exhausted externally, alternatively to reenergizes the motor manually change the rail tracks back to expending mode and a manual crank gearbox is provided to turn the top large sprocket gear whereby the entire motor starts to turn once enough buoyant bellow chambers has expanded thus displacing water thereby increasing buoyant force on the first side of the carrier lifting acting on the carrier begins to turn the motor continuously at the designed speed and torque.

In present invention the said motor can be duplicated many number of times and combined to be attached to a building to achieve the required torque to turn the gearbox whereby the generator of an appropriate capacity, additionally used as the water storage tank and as a fire hydrant, furthermore combination of the said motors can be implemented to turn large piston water pumps accumulatively at the coast, rivers and lakes to pump water up a mountain top with a large reservoir tank to store water whereby to run a hydro generator continuously, 24/7.

### BRIEF DESCRIPTION OF THE DRAWINGS

FIG. 1 illustrate an overall view of the a 5 story building equipped with a gravity and buoyancy motor turning a gearbox whereby a generator, furthermore additional unit of the motor can be added to overcome the demand

FIG. 2 depicts a plan view comprehending the amount of the ground the motor occupy.

FIG. 3 depicts a oblique view of a gravity and buoyancy motor assembled

FIG. 4 depicts a side elevation of a gravity and buoyancy motor generator.

FIG. 5 depicts a front elevation of a gravity and buoyancy motor generator.

FIG. 6 depicts a compressed or the collapsed side of the motor and the expended side of the motor.

FIG. 7 depicts an exploded view of a bellow chamber module.

FIG. 8 depicts the tracks and structure details.

FIG. 9 depicts a plan view and oblique details of the sprocket chain.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for the purpose of illustration and description only; it is not intended to be exhaustive or be limited to the precise form disclosed.

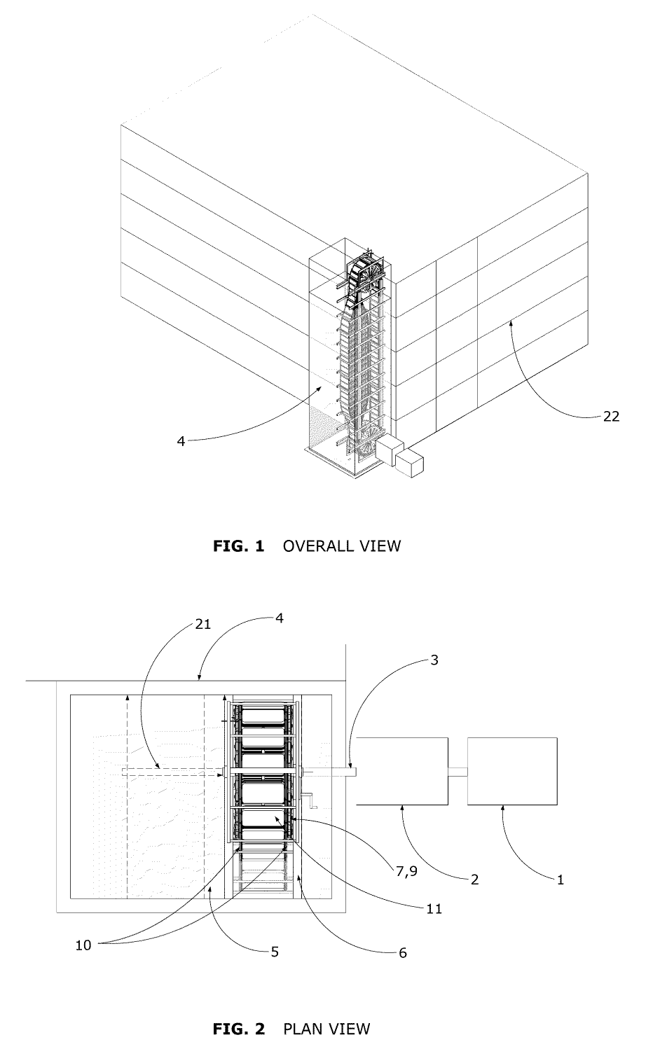

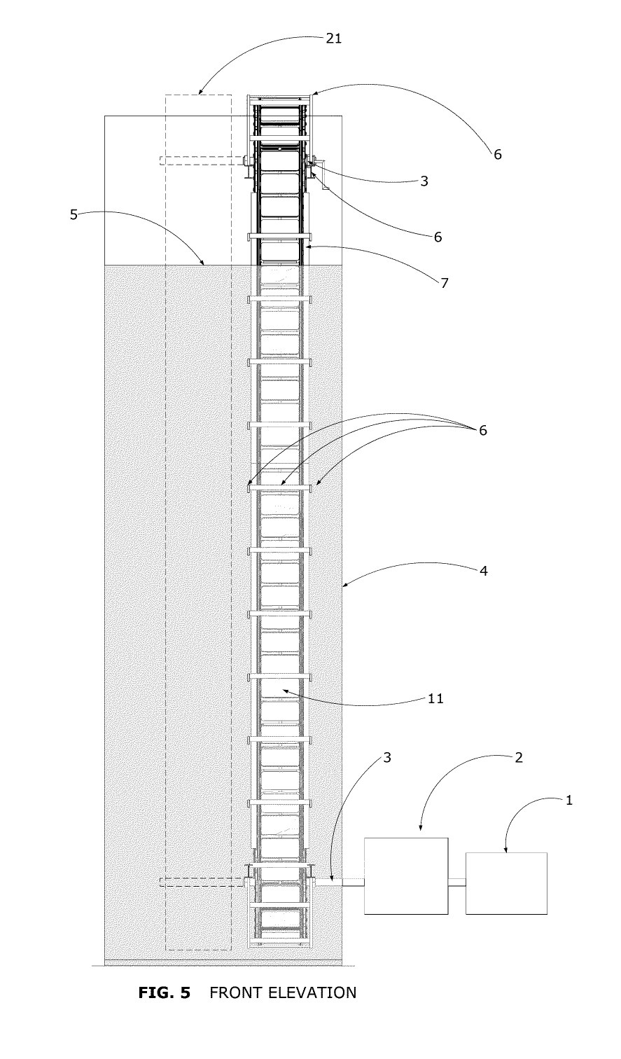

Referring particularly to the drawings, there is shown in FIG. 1 the first embodiment of gravity motor placed in a tank 4 next to the five story high rise building 22 whereby addition unit of identical motors can be attached as shown in FIG. 5 (#21) next to each other in a common tank to drive as a common shaft 3 to the gearbox 2 to meet and to overcome respectively the required torque and speed/frequency to generate alternating current. It is further understood that the present invention can be attached to a commercial building or to supply power to a suburban subdivisions or a village and or a residential home for that matter.

Referring to FIG. 2 is plan view showing how much of a ground space the present invention is occupying in proportion to the building in FIG. 1

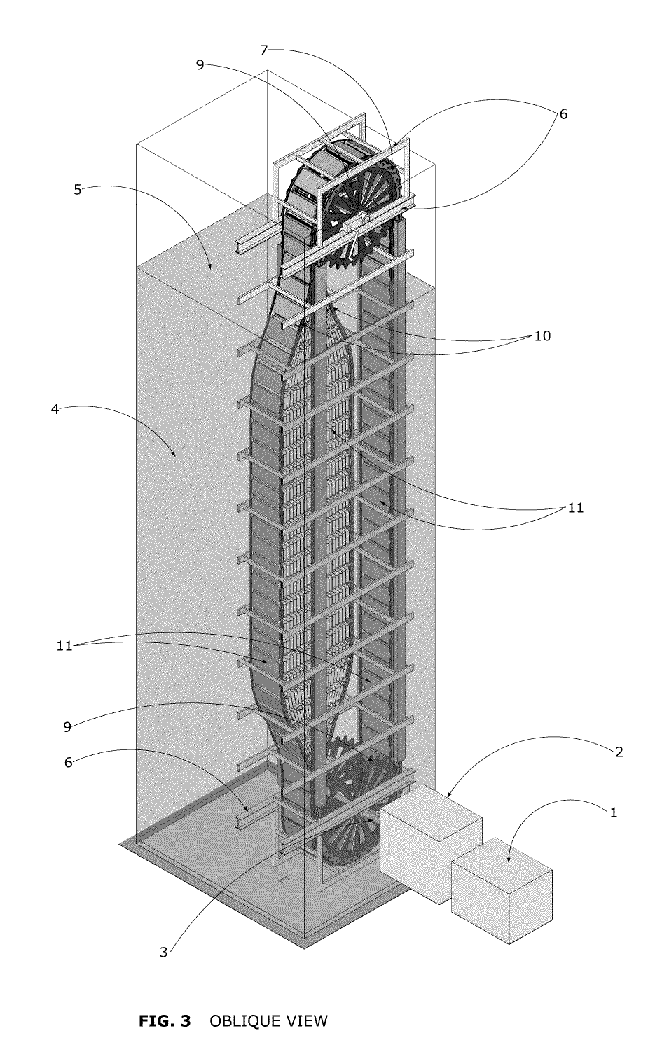

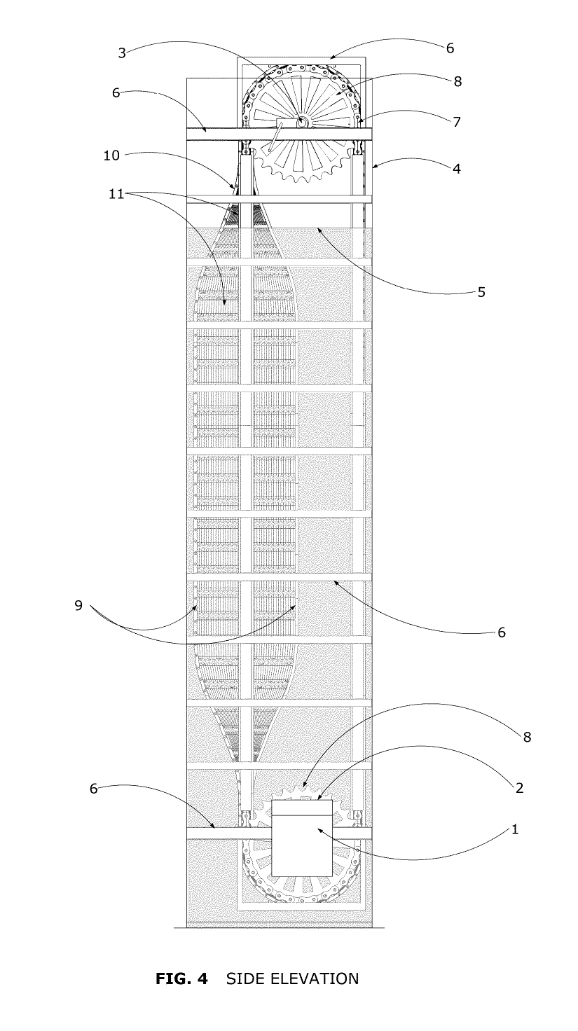

Referring to FIGS. 3, 4, and 5 a gravity motor (engine) a machine is defined as a device which modifies energy from a natural source (gravity) by use and inclusion of other natural aspect buoyancy a byproduct of gravity by expanding and collapsing the bellow skit chambers in a synchronized manner linked together 11 the entire travel cycle in a upright column 6. This said support structure 6 encases the entire mechanism that is immersed in a tank 4 almost fill with fluid 5 (preferably water). The top of the support structure 6 a pair of sprocket gear 9 on a shaft is mounted on bearings, that is further connected to a crank gearbox 25, the bottom set of identical sprocket gears in a shaft is mounted on bearing extending to a gearbox 2 whereby the generator 1. There are two identical set of sprocket chains 7 attached parallelly to the sprocket gears 9 as carriers of the bellow chambers 13 on conveyer, furthermore there are two sets of guide rail 10 to expend and collapse the bellow chambers 13 on both sides of the each sprocket chain 7, as shown in FIG. 4 where the guide rails are divided between each sprocket chain 7. There are two sides of the motor one is expending bellow chamber side (buoyant left side) is first side and the collapsed side (gravity right side) is the second side of the said motor, thus in this case the motor only turns clockwise viewed from the generator side as seen in FIG. 3. On the first side of the said motor there are two sets of guides' rails 10 running parallel on both sides of the sprocket chain carrier, the guide rails that are running adjacent to the sprocket chain carrier 7 are there to collapse the bellow chamber and the two guide rails away from the sprocket chain carrier are the expending the bellow chambers (buoyant force) on the first side of the carrier, the said sets of rail guide both, the expanding and the collapsing has a manual rail change 20 design operated from the top of the water tank 4 to change the guide rail tracks 10 in order start or to shut the motor down from the first side of the motor.

To get the present invention in motion thereby produce electricity is achieved by setting the rail guide to the expending mode 20 there upon manually crank gearbox 25 as the crank gearbox starts turning the large sprocket gears 9 clockwise, thereby as the said sprocket gears turns the first sets of bellow cambers begins to expend on the first side of the motor and additionally takes in atmospheric air in from the top of the tank as more chamber enter the first side of the motor and expends the volume of water the said chambers have displaced increases creating a buoyant force on the first side of the motor, finally when the force of the buoyant bellow chamber have reach a point to carry the sprocket chain carrier 7 and turn the sprocket gear 9 on its own, the manual crank 25 is disengaged and the motor starts picking up speed as more of the said bellow chambers enter the buoyant side of the motor, once all the specified amount of bellow chambers have expended on the first side as per design the rpm on the generator will maintain content as specified, and the routine movement of the bellow chambers of expanding and collapsing is synchronized thus continuously turning the gearbox 2 whereby the generator 1.

To shut down the said motor is to change the guide rail 20 to a collapsing mode from the top of the tank 4 and as the bellow chambers enter the first side the chambers stop expending and expelling the air at the top as each chamber at the top collapses thus maintain the collapsed cycle and reducing the buoyant force on the first side of the motor sprocket chain carrier 7 thereby causing the momentum of the sprocket gears 9 to slow down finally all the bellow chambers to collapse and the motor comes to rest.

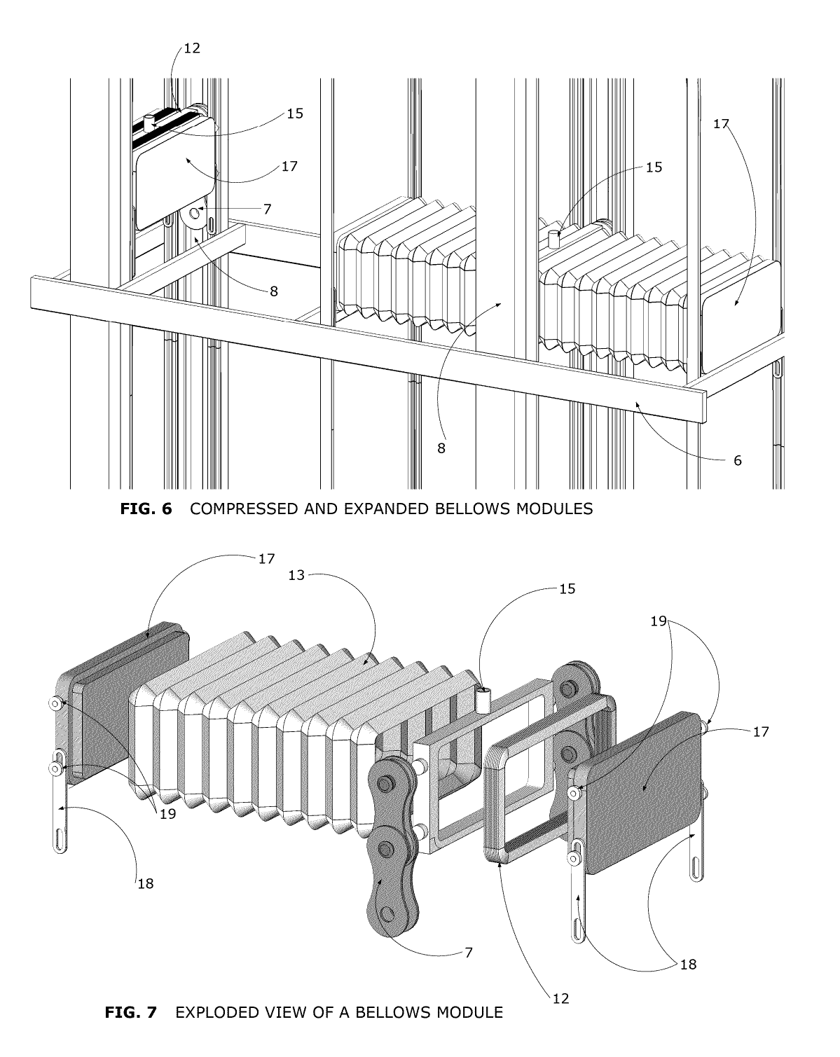

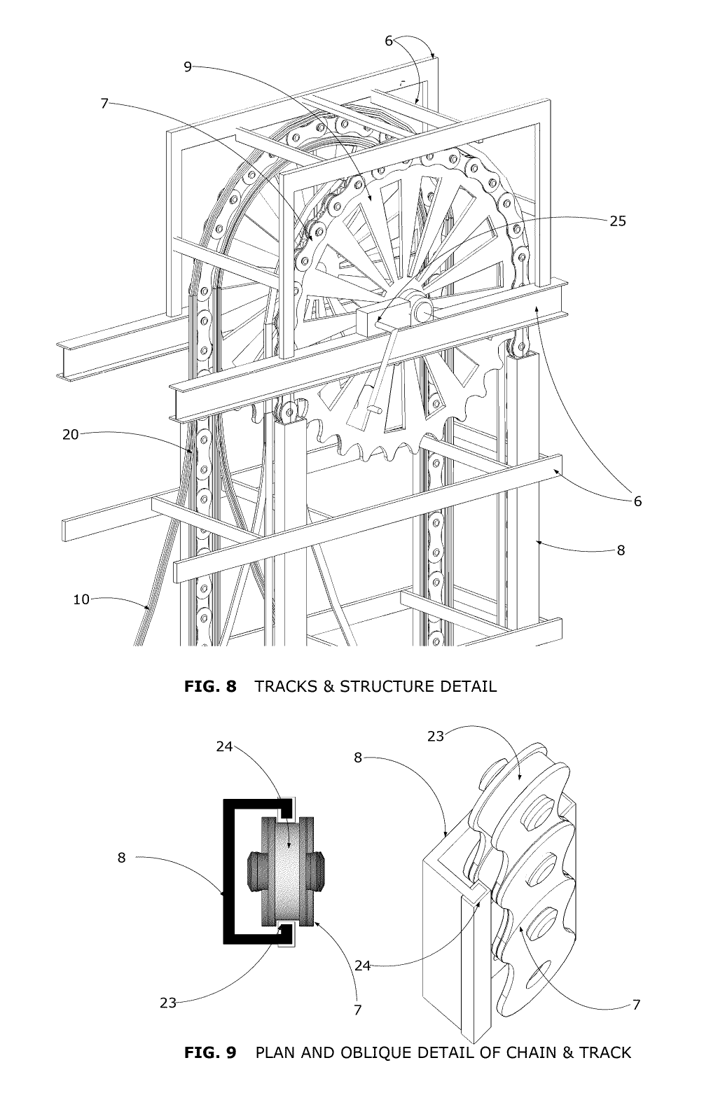

Referring to FIG. 6 compressed or the collapsed side of the motor and the expended side of the motor. Each and every bellow chamber modules 13 glides on bearings for smooth and with least amount of friction including the sprocket chain carrier 7 that rides on the chain track carrier guide 8 on bearings as shown in FIG. 8, furthermore as the top bellow chamber collapses on the first side of the motor the air in the collapsing chamber is exhausted thereby directed to the expending chamber below on the first side simultaneously as a closed circuit thus the said motor does not exert more energy to compress the air in the collapsing bellow chamber.

Referring to FIG. 7 there are two types of expanding and collapsible chambers in the present invention; the one is as shown a bellow skit type chamber 13 and the second not shown is telescopic tube type where the largest tube is attached to sprocket chain (carrier) on a pressurized air pipe connecting frame 15 and the smallest tube of the said collapsible telescopic chamber is attached to the centre that pivots on metal end cap 17 and rides on bearing 19 guided by the track 10. Each and every tube in the said telescopic chamber has a sealed shoulder to seal and stop to its limits thus as the collapsible telescopic chamber expands preventing water entering the expanded chamber thus maintaining the buoyancy, furthermore the entire telescopic chamber could be covered with a vinyl foldable sealed skin or marine suitable material to maintain water from entering the said telescopic chamber thus there would be no need of seal on shoulders of each connected tube that make up the telescopic chamber. The said collapsible and expanding telescopic chamber and the bellow chamber 13 may be made of steel, aluminum, titanium, carbon fiber, reinforced material, rubber with composite material with water tight integrity suitable for marine application, furthermore the said collapsible chambers can be of a circular, square, rectangular, triangular or polygonal in shapes to accommodate the objective.

Referring to FIGS. 8 and 9 a conveyer bellow chamber carrier is the sprocket chain 7 with bearing inserts 23 cycles around between the top sprocket gears 9 and the bottom sprocket gears, furthermore the rail guides plays a major role in maintaining the a constant supply of expanded buoyant bellow chambers thus achieving the objective.

From the foregoing it can be seen that an apparatus has been devised using both the principles of gravity and buoyancy to affect a power output with no fossil fuel or other combustion neither wind energy or solar energy. The motor apparatus of the invention is clean and efficient yet highly effective in providing a significant power output to power input multiple.

The following are the reference number to each part in the set of drawings enclosed
1. Generator
2. Transmission
3. Shaft
4. Tank with the motor inserted
5. Fluid preferably water
6. Support structure
7. Sprocket drive chain/carrier
8. Chain track/carrier guide
9. Sprocket gear
10. Guide tracks to expend and collapse the bellow chambers
11 Bellow modules chained together
12 Compressed bellows
13 Expanded bellows
14 Chamber frame fixed to the sprocket chain
15 Pressurized air pipe connecting frames forming
A Closed loop air circuit
16 Rubberized, vinyl reinforced
17 Metal end cap
18 Restraining straps
19 Guide wheel
20 Track switch for changing tracks
21 Additional machine modules to increase power output
22 Attached building
23 Sprocket chain roller bearing insert
24 Teflon guide insert on the sprocket chain guide
25 Manual or powered crank

This invention would solve most of the global energy issues as following;
Economic Development;
Greenhouse Gas Emissions Reduction;
Improved Reliability;
Air Quality Improvement;
Environmental Justice;
Policy Leadership/State or political.

### ILLUSTRATIVE EMBODIMENTS

Although this invention has been described in certain specific embodiments, many additional modifications and variations would be apparent to those skilled in the art. It is, therefore, to be understood that this invention may be practiced otherwise than as specifically described. Moreover, to those skill in the various arts, the invention itself herein will suggest solutions to other tasks and adaptations for other applications. Thus, the embodiments of the invention described herein should be considered in all respects as illustrative and nor restrictive, the scope of the invention to determined by the appended claims and their equivalent rather than foregoing description.

What is claimed:

1. A gravity and buoyancy actuated apparatus (a motor) for generating electrical power, or pumping water, said apparatus comprising of;
a housing or tank which extends up to the top deck of a building and the said housing containing a liquid therein;
a vertically disposed conveyer mounted within said housing, said conveyer having downwardly support structure mounted vertically;
a plurality of sprocket gears encased in the said support structure as part of motor disposed in the said housing;
a plurality of sprocket chains carrier sets and its guide are also encased in said support structure;
a sprocket gear shaft at the top section of the motor is connected to a hand crank gearbox;
a plurality of collapsible and expandable bellow chambers are mounted on the said conveyer equally space intervals or plurality collapsible and expanding telescopic chambers equally spaced intervals;
a plurality of rail guides to expend and collapse the said bellow camber on the said motor;
the set of changeable rail guides specifically on the first side of the said motor to shut the motor down;
a plurality of sprocket chain rail guides with Teflon to guide the sprocket chain carrier with bearings inserts;
the sprocket gears on a shaft at the bottom section of the motor are connected to a gearbox or a water pump.

2. A gravity and buoyancy actuated apparatus (a motor) of claim 1 wherein the gearbox or the water pump can be connected at top shaft of the said motor thereby achieve same results.
